(19) United States
(12) Patent Application Publication
(10) Pub. No.: US 2025/0271044 A1
(43) Pub. Date: Aug. 28, 2025

(54) TUBULAR VIBRATION-DAMPING DEVICE FOR MOTOR MOUNT

(71) Applicant: Sumitomo Riko Company Limited, Komaki-shi (JP)

(72) Inventors: Takuma HARADA, Komaki-shi (JP); Takayoshi Yasuda, Komaki-shi (JP); Natsuki Sumida, Komaki-shi (JP)

(73) Assignee: Sumitomo Riko Company Limited, Komaki-shi (JP)

(21) Appl. No.: 18/981,885

(22) Filed: Dec. 16, 2024

(30) Foreign Application Priority Data
Feb. 23, 2024 (JP) 2024-026059

(51) Int. Cl. F16F 1/38; F16F 1/36

(52) U.S. Cl. CPC F16F 1/3835; F16F 1/3605

(57) ABSTRACT

A tubular vibration-damping device for a motor mount including: a first molded article including: an inner shaft member; an intermediate sleeve receiving the inner shaft member being inserted therein; and an inner rubber elastic body connecting the inner shaft member and the intermediate sleeve elastically in a radial direction; and a second molded article including: an outer tube member; and an outer peripheral rubber elastic body being bonded to an inner surface of the outer tube member, wherein the intermediate sleeve of the first molded article is fitted radially into the outer peripheral rubber elastic body of the second molded article so as to combine the first molded article and the second molded article in a non-adhesive manner.

### INCORPORATED BY REFERENCE

The disclosure of Japanese Patent Application No. 2024-026059 filed on Feb. 23, 2024 including the specification, drawings and abstract is incorporated herein by reference in its entirety.

### BACKGROUND ART

### 1. Technical Field

The present disclosure relates to a tubular vibration-damping device for a motor mount used for vibration-damping support of an electric motor, for example, in an electrification vehicle.

### 2. Description of the Related Art

Conventionally, a tubular vibration-damping device such as a cylindrical rubber bushing shown in Japanese Unexamined Patent Publication No. JP-A-S58-097508 has been known as a type of vibration-damping device used in a vehicle. The tubular vibration-damping device has a structure wherein an inner shaft fitting and an outer tube member are elastically connected by a main rubber elastic body. There is also shown in JP-A-S58-097508 a structure wherein an intermediate sleeve is arranged between an inner shaft member and the outer tube member, the inner shaft member and the intermediate sleeve are connected by an inner rubber elastic body, and the intermediate sleeve and the outer tube member are connected by an outer peripheral rubber elastic body.

### SUMMARY

In recent years, automobiles have become increasingly electrically powered, and in an electrification vehicle, a tubular vibration-damping device may be employed as a motor mount to connect an electric motor to a vehicle body in a vibration-damping manner.

However, the performance required for the tubular vibration-damping device for the motor mount is different from the performance required for the conventional tubular vibration-damping device as shown in JP-A-S58-097508. Thus, there was a risk that the required vibration-damping characteristics, durability, etc. may not be fully satisfied if the conventional tubular vibration-damping device is used for the motor mount.

It is therefore one object of the present disclosure to provide a tubular vibration-damping device for a motor mount of novel structure which is able to achieve a high level of performance required for the motor mount.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a tubular vibration-damping device for a motor mount comprising: a first molded article including: an inner shaft member; an intermediate sleeve receiving the inner shaft member being inserted therein; and an inner rubber elastic body connecting the inner shaft member and the intermediate sleeve elastically in a radial direction; and a second molded article including: an outer tube member; and an outer peripheral rubber elastic body being bonded to an inner surface of the outer tube member, wherein the intermediate sleeve of the first molded article is fitted radially into the outer peripheral rubber elastic body of the second molded article so as to combine the first molded article and the second molded article in a non-adhesive manner.

With the tubular vibration-damping device for the motor mount constructed in accordance with the present preferred embodiment, a mass-spring system (a sub-vibration system) is configured between the inner shaft member and the outer tube member, with the intermediate sleeve of the first molded article serving as the mass and the inner rubber elastic body of the first molded article and the outer peripheral rubber elastic body of the second molded article serving as the springs. This reduces the transmission rate of a vibration at a higher frequency than the resonance frequency of the mass-spring system. Therefore, a high-frequency small-amplitude vibration, which can be a problem especially in the motor mount, is hardly transmitted between the inner shaft member and the outer tube member, and it is possible to achieve excellent vibration-damping performance as the motor mount.

Since the first molded article and the second molded article are combined in the non-adhesive manner, it is easy to set the spring characteristics of the inner rubber elastic body in the first molded article and the spring characteristics of the outer peripheral rubber elastic body in the second molded article separately, which allows a large degree of freedom in tuning the resonance frequency of the mass-spring system. In particular, the large degrees of freedom in tuning the springs of the inner rubber elastic body and the outer peripheral rubber elastic body allows the resonance frequency of the mass-spring system to be tuned to a sufficiently low frequency even when the mass of the intermediate sleeve is relatively small. As a result, the vibration-damping action exerted against the vibration of a higher frequency than the resonance frequency of the mass-spring system can be obtained over a wider frequency range.

Compared with the case where the outer peripheral rubber elastic body is adhered to the outer peripheral surface of the intermediate sleeve, there is no need to press the outer peripheral rubber elastic body strongly against the outer peripheral surface of the intermediate sleeve, and the low spring characteristics of the outer peripheral rubber elastic body can be easily realized. Furthermore, the projecting distal end surface of the outer peripheral rubber elastic body is not adhered to the outer peripheral surface of the intermediate sleeve. Thus, for example, when the outer peripheral rubber elastic body is compressed in advance in the radial direction by reducing the diameter of the outer tube member, the pre-compression can be performed to the extent that dislodgment of the first molded article from the outer peripheral rubber elastic body is prevented, while the spring of the outer peripheral rubber elastic body can be prevented from becoming excessively hard.

A second preferred embodiment provides the tubular vibration-damping device for the motor mount according to the first preferred embodiment, wherein the outer peripheral rubber elastic body has a tapered cross sectional shape whose axial length dimension gets smaller as it goes radially inward.

With the tubular vibration-damping device for the motor mount constructed according to the present preferred embodiment, the outer peripheral rubber elastic body has a cross sectional shape that tapers as it goes toward the intermediate sleeve. Thus, for example, when the intermediate sleeve is fitted radially inside the outer peripheral rubber elastic body and the outer peripheral rubber elastic body is compressed in the radial direction, even if a relatively large compression allowance is set in the outer peripheral rubber elastic body, the spring of the outer peripheral rubber elastic body is prevented from becoming excessively stiff.

Since the outer peripheral rubber elastic body is not adhered to the intermediate sleeve, the outer peripheral rubber elastic body does not need to be pressed strongly against the intermediate sleeve, compared with the case when the outer peripheral rubber elastic body and the intermediate sleeve are adhered. Therefore, although the outer peripheral rubber elastic body has a tapered cross sectional shape so as to soften the spring characteristics of the outer peripheral rubber elastic body, it is possible to effectively get the assembly holding force between the first molded article and the second molded article.

A third preferred embodiment provides the tubular vibration-damping device for the motor mount according to the first or second preferred embodiment, wherein an axial length dimension of a radially inner end of the outer peripheral rubber elastic body is within 30 to 200% of a projecting height dimension of the outer peripheral rubber elastic body to a radially inner side from the outer tube member.

With the tubular vibration-damping device for the motor mount structured according to the present preferred embodiment, the axial length dimension of the radially inner end of the outer peripheral rubber elastic body is 30% or more of the projecting height dimension of the outer peripheral rubber elastic body. This ensures a sufficient contact area between the projecting distal end surface of the outer peripheral rubber elastic body and the outer peripheral surface of the intermediate sleeve, thereby preventing the intermediate sleeve from slipping out of the outer peripheral rubber elastic body. In addition, the axial length dimension of the radially inner end of the outer peripheral rubber elastic body is 200% or less of the projecting height dimension of the outer peripheral rubber elastic body. This ensures a sufficiently large rubber thickness of the outer peripheral rubber elastic body in the radial direction and facilitates the realization of low spring characteristics of the outer peripheral rubber elastic body by its cross sectional shape.

A fourth preferred embodiment provides the tubular vibration-damping device for the motor mount according to any one of the first through third preferred embodiments, wherein the outer peripheral rubber elastic body has an annular shape continuous over an entire circumference.

With the tubular vibration-damping device for the motor mount constructed according to the present preferred embodiment, when the intermediate sleeve is fitted and the outer peripheral rubber elastic body is compressed in the radial direction, the deformation of the outer peripheral rubber elastic body is limited in the circumferential direction. Therefore, the action of the outer peripheral rubber elastic body to hold the intermediate sleeve is effectively demonstrated, thereby avoiding the intermediate sleeve from slipping out of the outer peripheral rubber elastic body.

A fifth preferred embodiment provides the tubular vibration-damping device for the motor mount according to any one of the first through fourth preferred embodiments, wherein the outer peripheral rubber elastic body has a spring reducing part reducing a spring in the radial direction provided partially in a circumferential direction.

With the tubular vibration-damping device for the motor mount constructed according to the present preferred embodiment, the outer peripheral rubber elastic body is provided with the spring reducing part to lower the spring of the outer peripheral rubber elastic body, which constitutes the spring of the sub-vibration system. Therefore, the resonance frequency of the sub-vibration system with the intermediate sleeve serving as the mass can be easily tuned to a lower frequency, and the vibration-damping action of the sub-vibration system can be effectively obtained from a lower frequency range.

Since the spring reducing part, which reduces resistance to dislodgment of the intermediate sleeve, is provided partially in the circumferential direction, the resistance to dislodgment of the intermediate sleeve can be secured by the portion of the outer peripheral rubber elastic body that is out of the spring reducing part in the circumferential direction.

A sixth preferred embodiment provides the tubular vibration-damping device for the motor mount according to any one of the first through fifth preferred embodiments, wherein the inner rubber elastic body has a plurality of bored holes penetrating it in an axial direction.

With the tubular vibration-damping device for the motor mount constructed according to the present preferred embodiment, the bored holes are provided in the inner rubber elastic body to lower the spring of the inner rubber elastic body. Moreover, by providing the bored holes in the inner rubber elastic body, it is possible to realize tuning of the spring characteristics while securing the action of the outer peripheral rubber elastic body to retain the intermediate sleeve.

According to the present disclosure, it is possible to achieve the high level of performance required for the tubular vibration-damping device for the motor mount.

### BRIEF DESCRIPTION OF THE DRAWINGS

The foregoing and/or other objects, features and advantages of the disclosure will become more apparent from the following description of practical embodiments with reference to the accompanying drawings in which like reference numerals designate like elements and wherein:

FIG. 1 is a perspective view showing a tubular vibration-damping device for a motor mount as a first practical embodiment of the present disclosure;

FIG. 2 is a front view of the tubular vibration-damping device for the motor mount shown in FIG. 1;

FIG. 3 is a cross sectional view taken along line 3-3 of FIG. 2;

FIG. 4 is a cross sectional view taken along line 4-4 of FIG. 2;

FIG. 5 is a cross sectional view taken along line 5-5 of FIG. 2;

FIG. 6 is an exploded perspective view of the tubular vibration-damping device for the motor mount shown in FIG. 1;

FIG. 7 is a front view of a first molded article constituting the tubular vibration-damping device for the motor mount shown in FIG. 1;

FIG. 8 is a front view of a second molded article constituting the tubular vibration-damping device for the motor mount shown in FIG. 1;

FIG. 9 is a graph indicating vibration-damping characteristics of the tubular vibration-damping device for the motor mount of FIG. 1;

FIG. 10 is a perspective view showing a tubular vibration-damping device for a motor mount as a second practical embodiment of the present disclosure;

FIG. 11 is a front view of the tubular vibration-damping device for the motor mount shown in FIG. 10;

FIG. 12 is a cross sectional view taken along line 12-12 of FIG. 11;

FIG. 13: a perspective view of a second molded article constituting the tubular vibration-damping device for the motor mount shown in FIG. 10; and

FIG. 14 is a front view of the second molded article shown in FIG. 13.

### DETAILED DESCRIPTION

There will be described practical embodiments of the present disclosure, with reference to the drawings.

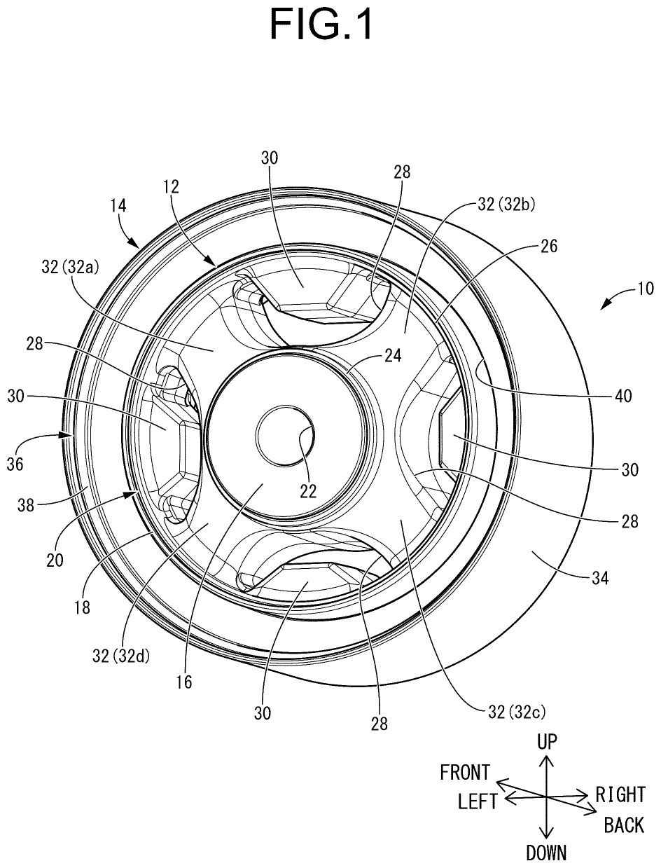

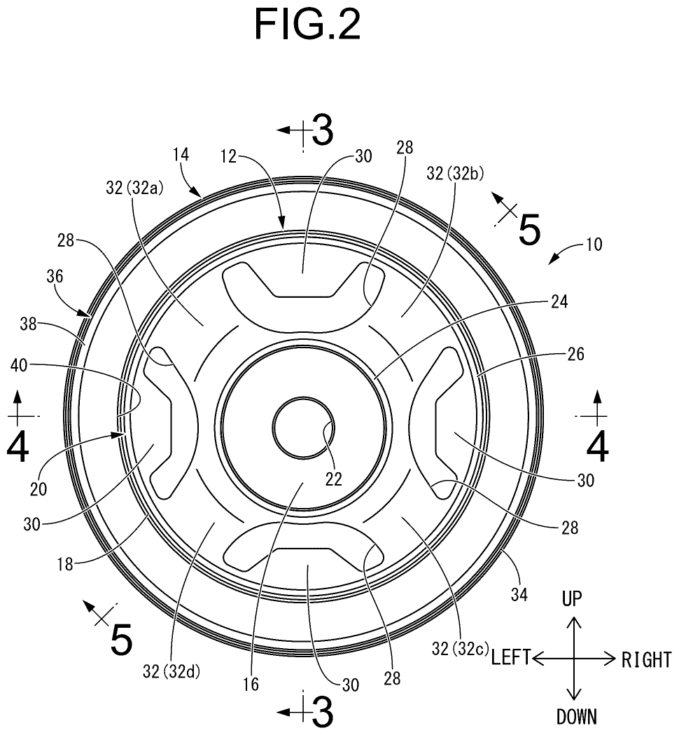

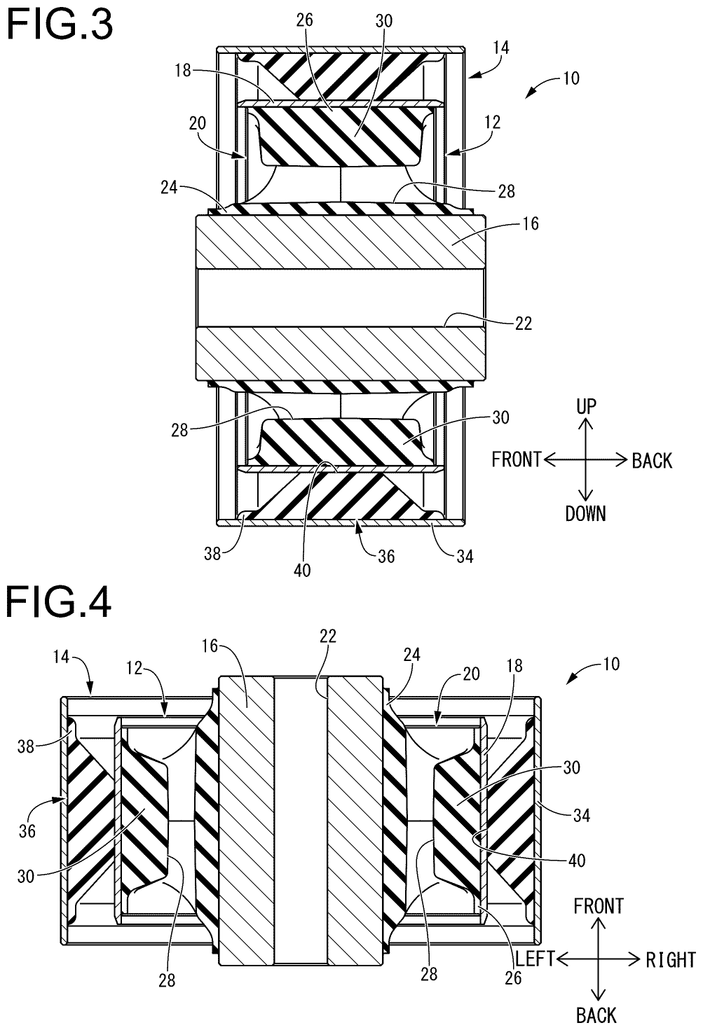

FIGS. 1 to 5 show a tubular vibration-damping device 10 for a motor mount (hereinafter referred to as the tubular vibration-damping device 10) as a first practical embodiment of this disclosure. The tubular vibration-damping device 10 comprises a first molded article 12 and a second molded article 14. In the following explanation, in principle, the up-down direction means the up-down direction in FIG. 2, the left-right direction means the left-right direction in FIG. 2, and the front-back direction means the left-right direction in FIG. 3.

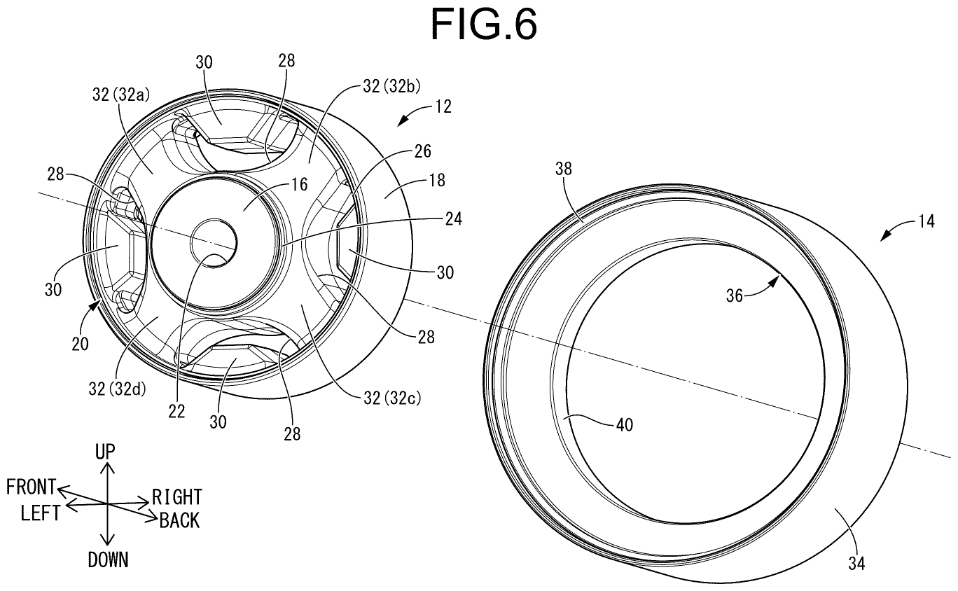

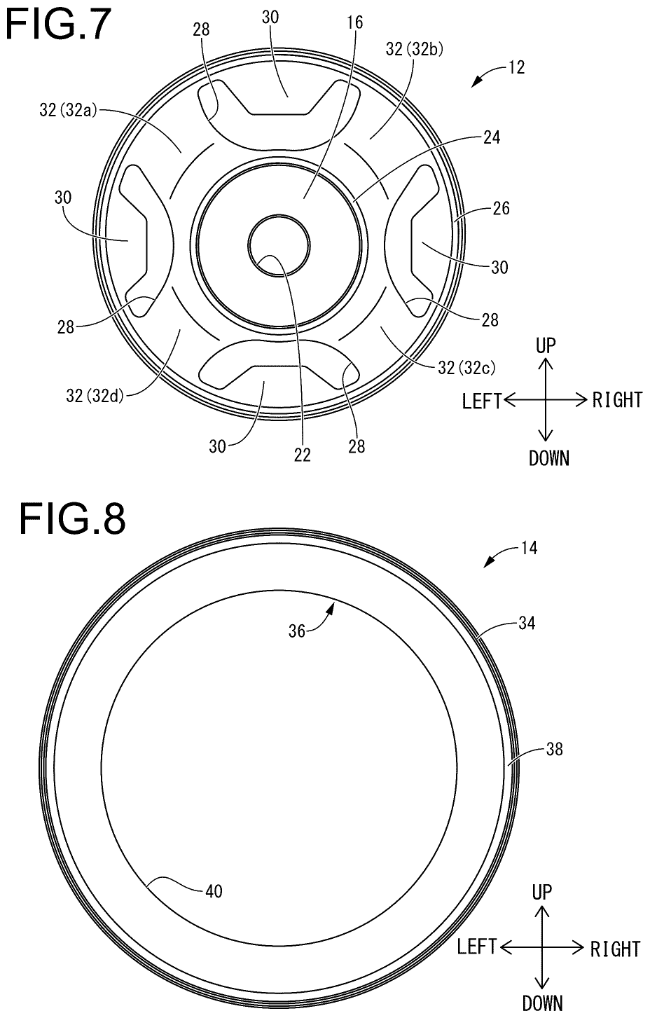

As also shown in FIGS. 6 and 7, the first molded article 12 has a structure wherein an inner shaft member 16 is inserted in an intermediate sleeve 18, and those inner shaft member 16 and intermediate sleeve 18 are elastically connected to each other by an inner rubber elastic body 20.

The inner shaft member 16 has a thick-walled, small-diameter, generally cylindrical shape and it is provided with a bolt hole 22 that passes through it in the axial direction. The inner shaft member 16 is made of a metal or a fiber-reinforced synthetic resin, etc., for example, and is a highly rigid member.

The intermediate sleeve 18 has a thin-walled, large-diameter, generally cylindrical shape, with an inner diameter dimension larger than the outer diameter dimension of the inner shaft member 16. The intermediate sleeve 18 is made of a metal or a fiber-reinforced synthetic resin, etc., for example, and is a highly rigid member. More preferably, the intermediate sleeve 18 is made of a metal such as iron or an aluminum alloy, whereby a diameter reduction process such as 360-degree radial compression can be easily performed on the intermediate sleeve 18. The axial end of the intermediate sleeve 18 has a tapered outer peripheral surface with a smaller diameter as it goes outward in the axial direction, and its outer diameter dimension gets smaller as it goes outward in the axial direction.

The inner rubber elastic body 20 has a substantially cylindrical shape as a whole, and its inner surface is bonded by vulcanization to the outer peripheral surface of the inner shaft member 16, and its outer peripheral surface is bonded by vulcanization to the inner surface of the intermediate sleeve 18. The inner rubber elastic body 20 takes the form of an integrally vulcanization molded component incorporating the inner shaft member 16 and the intermediate sleeve 18. The inner rubber elastic body 20 has a radially inner end as a generally cylindrical radially inner bonded part 24 which is bonded to the inner shaft member 16, and an outer peripheral end as an outer peripheral bonded part 26 with a thin-walled, generally cylindrical shape which is bonded to the intermediate sleeve 18.

The inner rubber elastic body 20 has four bored holes 28, 28, 28, 28. The bored holes 28 each penetrate the inner rubber elastic body 20 in the front-back direction, i.e., the axial direction. The four bored holes 28, 28, 28, 28 are provided on both sides of the inner shaft member 16 in the up-down direction and on both sides in the left-right direction. The bored holes 28 are each provided with a stopper rubber 30 projecting from the intermediate sleeve 18 side toward the inner shaft member 16. The stopper rubber 30 has a tapered shape that becomes narrower in the circumferential direction as it goes to the radially inner side, which is the side of the projecting distal end of the stopper rubber 30. The stopper rubber 30 limits the amount of relative displacement between the inner shaft member 16 and the intermediate sleeve 18 by contacting the inner shaft member 16 side, thereby constituting a stopper mechanism that prevents excessive deformation of the inner rubber elastic body 20.

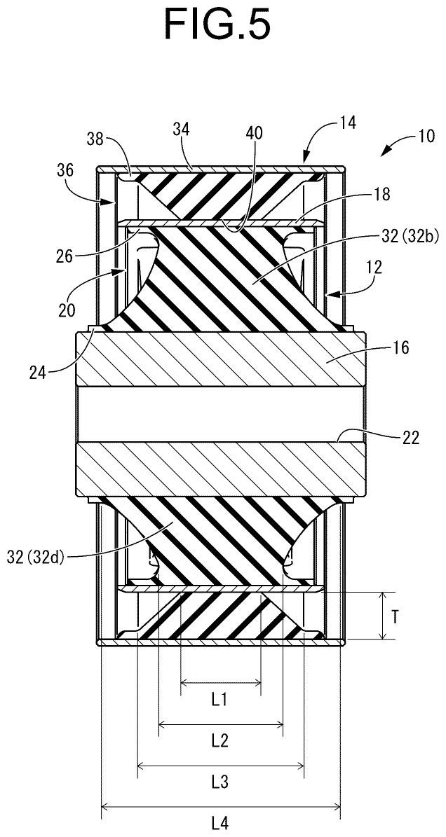

The inner rubber elastic body 20 has rubber legs 32 extending between adjacent bored holes 28, 28 in the circumferential direction. The rubber legs 32 are provided between the four bored holes 28, 28, 28, 28 in the circumferential direction. The inner shaft member 16 and the intermediate sleeve 18 are connected to each other by the four rubber legs 32a, 32b, 32c, 32d. The upper left rubber leg 32a extends upward from the inner shaft member 16 toward the intermediate sleeve 18, sloping to the left side. The upper right rubber leg 32b extends upward from the inner shaft member 16 toward the intermediate sleeve 18, sloping to the right side. The lower right rubber leg 32c extends downward from the inner shaft member 16 toward the intermediate sleeve 18, sloping to the right side. The lower left rubber leg 32d extends downward from the inner shaft member 16 toward the intermediate sleeve 18, sloping to the left side. The axial dimension of each rubber leg 32 gets smaller as it goes from the radially inner side to the radially outer side as shown in FIG. 5. Each rubber leg 32 has an end on the radially inner side that is continuous with the radially inner bonded part 24 and an end on the outer peripheral side that is continuous with the outer peripheral bonded part 26.

Reduction of the diameter of the intermediate sleeve 18 after molding the inner rubber elastic body 20 by vulcanization decreases tensile stress due to thermal contraction after molding of each rubber leg 32 in the inner rubber elastic body 20, thus improving the durability of the inner rubber elastic body 20 including the rubber legs 32.

The second molded article 14 has a structure wherein an outer peripheral rubber elastic body 36 is bonded to the inner surface of an outer tube member 34, as also shown in FIGS. 6 and 8.

The outer tube member 34 has a thin-walled, large-diameter, generally cylindrical shape, with an inner diameter dimension larger than the outer diameter dimension of the intermediate sleeve 18. The outer tube member 34 is a highly rigid member formed of a metal, a fiber-reinforced synthetic resin, or the like. More suitably, the outer tube member 34 is made of a metal such as iron or an aluminum alloy. The axial length dimension of the outer tube member 34 is smaller than the axial length dimension of the inner shaft member 16 and larger than the axial length dimension of the intermediate sleeve 18.

The outer peripheral rubber elastic body 36 has an annular shape as a whole and is continuous over the entire circumference in the circumferential direction with an approximately constant longitudinal cross sectional shape. The outer peripheral rubber elastic body 36 has the outer peripheral surface bonded by vulcanization to the inner surface of the outer tube member 34. The outer peripheral rubber elastic body 36 takes the form of an integrally vulcanization molded component incorporating the outer tube member 34. The outer peripheral end part of the outer peripheral rubber elastic body 36 is a thin-walled tubular bonded portion 38. At its outer peripheral surface, the tubular bonded portion 38 is bonded to the inner surface of the outer tube member 34. The outer peripheral rubber elastic body 36 may be made of the same rubber material as that of the inner rubber elastic body 20, but it is desirably made of a different rubber material so that the required performance of the inner rubber elastic body 20 and that of the outer peripheral rubber elastic body 36 can be highly realized respectively.

The radially inner side of the outer peripheral rubber elastic body 36 relative to the tubular bonded portion 38 has a tapered cross sectional shape whose axial length dimension gets smaller as it goes radially inward, as shown in FIGS. 3 to 5. The inner end surface of the outer peripheral rubber elastic body 36, which is the projecting distal end surface, is a cylindrical mating surface 40 that extends linearly in the axial direction in longitudinal cross section. The axial length dimension L1 of the mating surface 40 of the outer peripheral rubber elastic body 36 is suitably within 30 to 200%, more suitably within 40 to 180%, of the radial thickness dimension T, which is the radial projecting height dimension of the outer peripheral rubber elastic body 36 from the tubular bonded portion 38.

The axial length dimension L1 of the mating surface 40 is desirably smaller than the minimum axial length dimension L2 of the inner rubber elastic body 20. The axial length dimension of the mating surface 40 is suitably ⅔ or less of the axial length dimension of the intermediate sleeve 18, and more suitably ½ or less. Moreover, the axial length dimension of the mating surface 40 is suitably ¼ or more of the axial length dimension of the intermediate sleeve 18, and more suitably ⅓ or more. The maximum axial length dimension L3 of the portion of the outer peripheral rubber elastic body 36 excluding the tubular bonded portion 38 is larger than the minimum axial length dimension L1 of the outer peripheral rubber elastic body 36 and smaller than the maximum axial length dimension L4 of the inner rubber elastic body 20. It is desirable that L3>L2.

In the single state of the second molded article 14 to which the first molded article 12 is not assembled, the diameter of the mating surface 40, which is the inner diameter dimension of the outer peripheral rubber elastic body 36, should be smaller than the outer diameter dimension of the intermediate sleeve 18. The radial thickness dimension T of the outer peripheral rubber elastic body 36 is smaller than the radial thickness dimension of the inner rubber elastic body 20.

The first molded article 12 is inserted radially into the second molded article 14. That is, the intermediate sleeve 18 of the first molded article 12 is inserted radially inside the outer peripheral rubber elastic body 36 of the second molded article 14, and the outer peripheral surface of the intermediate sleeve 18 and the mating surface 40, which is the inner surface of the outer peripheral rubber elastic body 36, are overlapped with one another in direct contact. The mating surface 40 of the outer peripheral rubber elastic body 36 is elastically pressed against the outer peripheral surface of the intermediate sleeve 18 and is positioned relative to the intermediate sleeve 18 in the axial direction. As a result, the first molded article 12 is elastically held by the outer peripheral rubber elastic body 36 of the second molded article 14, and the first molded article 12 and the second molded article 14 are combined in a non-adhesive manner. The first molded article 12 and the second molded article 14 are combined to constitute the tubular vibration-damping device 10.

Since the mating surface 40 of the outer peripheral rubber elastic body 36 has a smaller diameter than that of the outer peripheral surface of the intermediate sleeve 18, the outer peripheral rubber elastic body 36 is compressed in the radial direction by inserting the intermediate sleeve 18 radially inside the outer peripheral rubber elastic body 36. By so doing, the mating surface 40 is pressed against the outer peripheral surface of the intermediate sleeve 18, and the intermediate sleeve 18 is elastically supported by the outer peripheral rubber elastic body 36. The displacement of the intermediate sleeve 18 relative to the mating surface 40 in the axial direction is limited by frictional resistance acting between the mating surface 40 and the outer peripheral surface of the intermediate sleeve 18.

Preferably, when the first molded article 12 is inserted radially inside the second molded article 14, the outer tube member 34 of the second molded article 14 is reduced in diameter, whereby the outer peripheral rubber elastic body 36 is further compressed in the radial direction between the intermediate sleeve 18 and the outer tube member 34. This more effectively prevents the intermediate sleeve 18 from slipping out in the axial direction. The mating surface 40 of the outer peripheral rubber elastic body 36 and the outer peripheral surface of the intermediate sleeve 18 are not adhered, so that the mating surface 40 is not excessively restrained by the intermediate sleeve 18 and the mating surface 40 of the outer peripheral rubber elastic body 36 is allowed to slide on the outer peripheral surface of the intermediate sleeve 18 when the outer tube member 34 is reduced in diameter. This avoids the spring of the outer peripheral rubber elastic body 36 from becoming excessively high due to the diameter reduction of the outer tube member 34. In addition, because the outer peripheral rubber elastic body 36 is not adhered to the intermediate sleeve 18, effective pre-compression can be easily and effectively applied in the radial direction to both the inner rubber elastic body 20 of the first molded article 12 and the outer peripheral rubber elastic body 36 of the second molded article 14, thereby improving durability and the like.

Since the mating surface 40 of the outer peripheral rubber elastic body 36 is not adhered to the outer peripheral surface of the intermediate sleeve 18, the pressing force against the outer peripheral surface of the intermediate sleeve 18 can be set relatively small. Therefore, excessive compression of the outer peripheral rubber elastic body 36 is unnecessary, and excessive restraint of the outer peripheral rubber elastic body 36 is also unnecessary, allowing the soft spring characteristics of the outer peripheral rubber elastic body 36.

Since the outer peripheral rubber elastic body 36 has a longitudinal cross sectional shape that tapers radially inward, the contact area between the mating surface 40, which is the inner end surface of the outer peripheral rubber elastic body 36, and the outer peripheral surface of the intermediate sleeve 18 is relatively small, and the spring of the outer peripheral rubber elastic body 36 is inhibited from becoming hard due to the restraint by the intermediate sleeve 18 on the mating surface 40. In addition, the outer peripheral rubber elastic body 36 has a tapered cross sectional shape, which lowers the spring of the outer peripheral rubber elastic body 36. In this practical embodiment, the axial length dimension L1 of the mating surface 40, which is the projecting distal end surface of the outer peripheral rubber elastic body 36, is smaller than the minimum axial length dimension L2 of the inner rubber elastic body 20, which realizes the low spring characteristics of the outer peripheral rubber elastic body 36. In this practical embodiment, the axial length dimension L1 of the mating surface 40 of the outer peripheral rubber elastic body 36 is ⅔ or less of the maximum axial length dimension L3 of the outer peripheral rubber elastic body 36, and is more suitably ½ or less, which is advantageous for getting even lower spring characteristics. Furthermore, the axial length dimension L1 of the mating surface 40 is set to be ⅓ or more of the maximum axial length dimension L3 of the outer peripheral rubber elastic body 36, which is also advantageous for securing the axial resistance to dislodgment.

In particular, the axial length dimension L1 of the mating surface 40 of the outer peripheral rubber elastic body 36 is set to be 200% or less of the radial thickness dimension T of the outer peripheral rubber elastic body 36, and the radial thickness dimension T of the outer peripheral rubber elastic body 36 is sufficiently large, thereby making it relatively easy to achieve low spring characteristics of the outer peripheral rubber elastic body 36. Besides, the axial length dimension L1 of the mating surface 40, which is the projecting distal end surface of the outer peripheral rubber elastic body 36, is 30% or more of the radial thickness dimension T of the outer peripheral rubber elastic body 36. This prevents the outer peripheral rubber elastic body 36 from becoming excessively soft and effectively realizes elastic support of the intermediate sleeve 18 by the outer peripheral rubber elastic body 36.

The outer peripheral rubber elastic body 36 of the present practical embodiment has an annular shape continuous with an approximately constant cross sectional shape over the entire circumference, and the mating surface 40 that contacts the outer peripheral surface of the intermediate sleeve 18 is a cylindrical surface continuous over the entire circumference. Therefore, the resistance to dislodgment exerted on the intermediate sleeve 18 is greater than when an outer peripheral rubber elastic body that is provided partially in the circumferential direction is employed, and the assembly state of the first molded article 12 and the second molded article 14 is maintained in a stable manner.

The inner rubber elastic body 20 bonded by vulcanization to both the inner shaft member 16 and the intermediate sleeve 18 is not required to hold other members by elasticity, so the portions connecting the inner shaft member 16 and the intermediate sleeve 18 are the four rubber legs 32a, 32b, 32c, 32d, mutually separated in the circumferential direction by the bored holes 28, thereby adjusting the spring characteristics. This effectively realizes the elastic support of the intermediate sleeve 18 owing to the annular outer peripheral rubber elastic body 36, while tuning the spring characteristics in the inner rubber elastic body 20.

In the tubular vibration-damping device 10 for the motor mount, the inner shaft member 16 is attached to the side of the electric motor (not shown) and the outer tube member 34 is attached to the side of the vehicle body (not shown), thereby mutually connecting the electric motor and the vehicle body in a vibration-damping manner. When the tubular vibration-damping device 10 is mounted on the vehicle, for example, upon input of vibration in the up-down direction between the inner shaft member 16 and the outer tube member 34, the vibration-damping action is achieved based on internal friction and the like between the inner rubber elastic body 20 and the outer peripheral rubber elastic body 36 interposed between the inner shaft member 16 and the outer tube member 34. This makes it possible to obtain vibration-damping effect of reducing the transmission of the vibration between the inner shaft member 16 and the outer tube member 34.

On the vibration transmission path from the inner shaft member 16 to the outer tube member 34, a mass-spring system (a sub-vibration system) is constituted by the intermediate sleeve 18 as a mass and the inner rubber elastic body 20 and the outer peripheral rubber elastic body 36 as springs. The resonance frequency of the mass-spring system is tuned to a frequency lower than the frequency of the vibration to be damped. For example, when requiring vibration-damping performance against a vibration of around 800 to 1500 Hz, the resonance frequency of the mas-spring system is tuned to around 500 Hz. By so doing, upon input of the vibration to be damped of a higher frequency than the resonance frequency of the mass-spring system, the vibration transmission rate from the inner shaft member 16 to the outer tube member 34 decreases and excellent vibration-damping performance is exhibited. In this practical embodiment, the entire tubular vibration-damping device 10 has an approximately symmetrical shape on both axial sides and the elastic main axes of the inner rubber elastic body 20 and the outer peripheral rubber elastic body 36 in the respective axis-perpendicular directions extend at the center in the axial direction. In addition, the inner surface of the outer peripheral rubber elastic body 36 that is overlapped on the intermediate sleeve 18 is not adhered and has a sufficiently small axial length. This suppresses transmission of vibration and displacement in the prizing direction and the torsional direction and enables the damping effect of the sub-vibration system on vibration in the axis-perpendicular direction to be more effectively demonstrated.

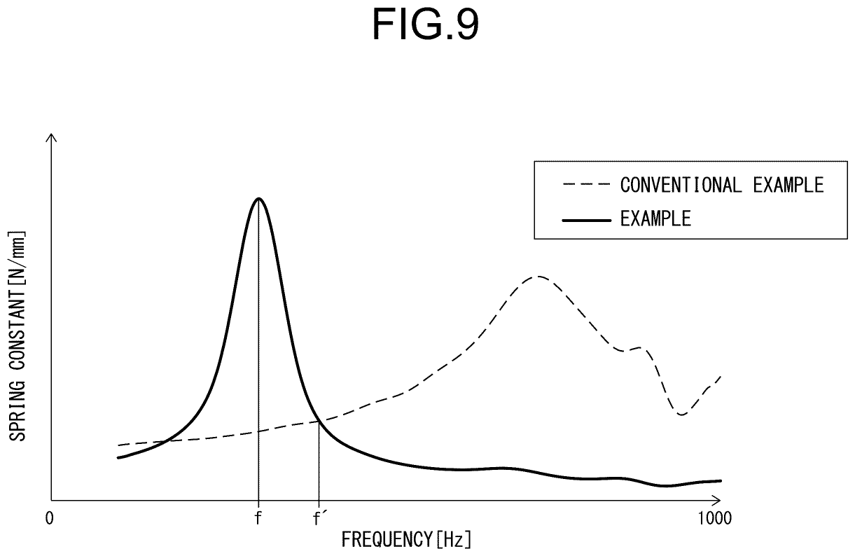

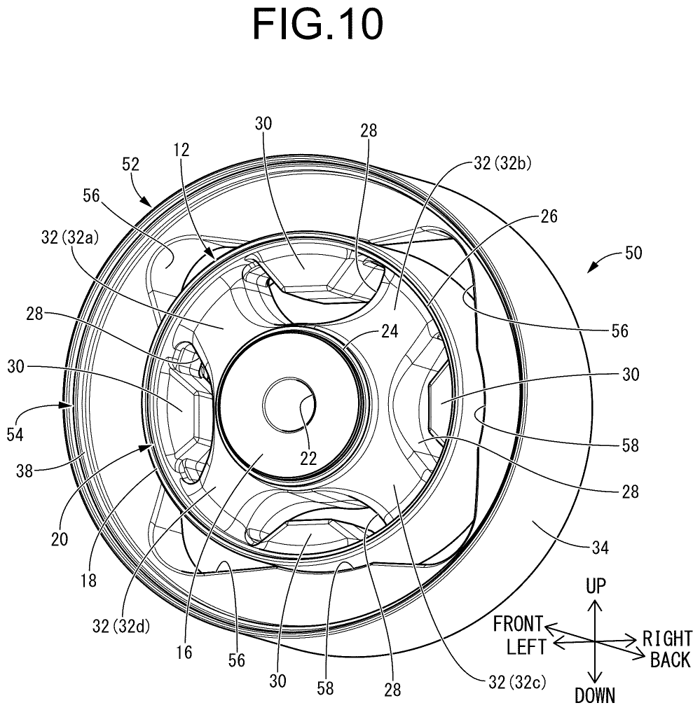

It is clear also from the graph shown in FIG. 9 that by utilizing the vibration-damping action of the sub-vibration system constituted by the intermediate sleeve 18, the inner rubber elastic body 20, and the outer peripheral rubber elastic body 36, higher vibration-damping performance can be achieved than with a conventional tubular vibration-damping device constituted only by the part corresponding to the first molded article 12. In FIG. 9, the solid line indicates the frequency characteristics of the spring constant in the tubular vibration-damping device 10 of this practical embodiment, while the dashed line indicates the frequency characteristics of the spring constant in the tubular vibration-damping device of the conventional structure. FIG. 9 shows that the tubular vibration-damping device 10 exhibits vibration-damping performance by vibration insulating action of the sub-vibration system in a higher frequency range than the resonance frequency f of the sub-vibration system, and that it exhibits vibration-damping performance by vibration insulating action more excellent than that of the tubular vibration-damping device of the conventional structure in a higher frequency range than frequency f′.

In the aforesaid mass-spring system, since the mass is constituted by the intermediate sleeve 18, it is difficult to set a large mass, and thus to set a low resonance frequency. In the tubular vibration-damping device 10, the outer peripheral rubber elastic body 36 is not adhered to the intermediate sleeve 18 so as to lower the spring of the outer peripheral rubber elastic body 36. This makes it possible to tune the resonance frequency of the mass-spring system to a lower frequency without increasing the mass of the intermediate sleeve 18, and possible to set the vibration-damping region of a higher frequency than the resonance frequency over a wider frequency range.

In this practical embodiment, the outer peripheral rubber elastic body 36 has a tapered cross sectional shape whose axial length dimension decreases as it goes radially inward. In addition, the axial length dimension L1 of the mating surface 40 of the outer peripheral rubber elastic body 36 is 200% or less of the projecting height dimension T of the outer peripheral rubber elastic body 36 in the radial direction. These contribute to setting a small spring constant of the outer peripheral rubber elastic body 36, which facilitates setting the resonance frequency of the mass-spring system to a lower frequency.

Furthermore, the spring of the inner rubber elastic body 20 is lowered by the formation of the four bored holes 28, 28, 28, 28. This lowers the spring of the mass-spring system including the inner rubber elastic body 20, and the resonance frequency of the mass-spring system can be tuned to a still lower frequency.

When the inner rubber elastic body 20 and the outer peripheral rubber elastic body 36 are made of different rubber materials, it becomes easy to set different performances, for example, to achieve low spring characteristics owing to the inner rubber elastic body 20 and to secure the holding force (resistance to dislodgment) for the first molded article 12 in the outer peripheral rubber elastic body 36. In particular, since the inner rubber elastic body 20 and the outer peripheral rubber elastic body 36 are independent and separate rubber bodies, they can be easily formed with different rubber materials, making it even easier to set the different characteristics of the inner rubber elastic body 20 and the outer peripheral rubber elastic body 36.

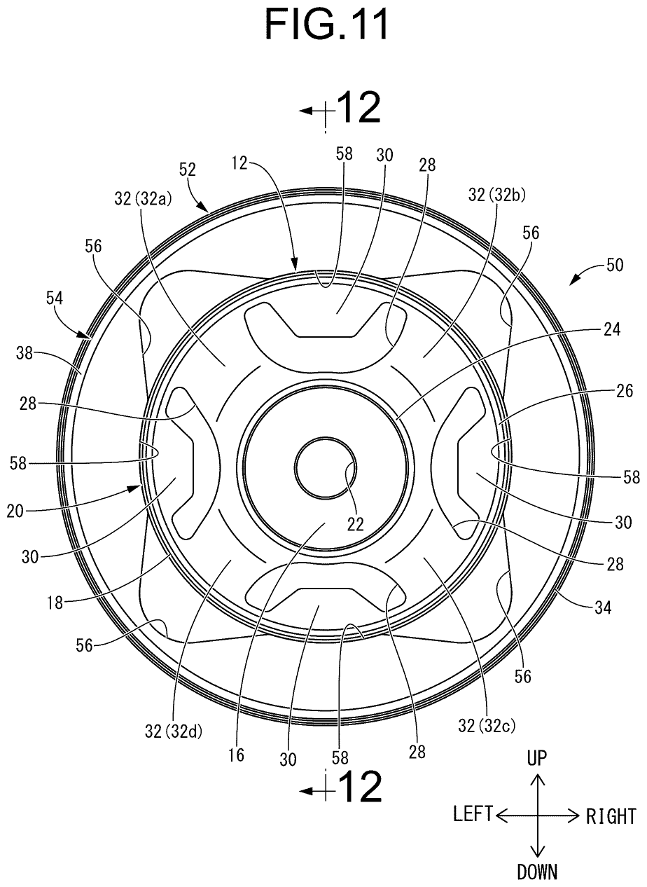

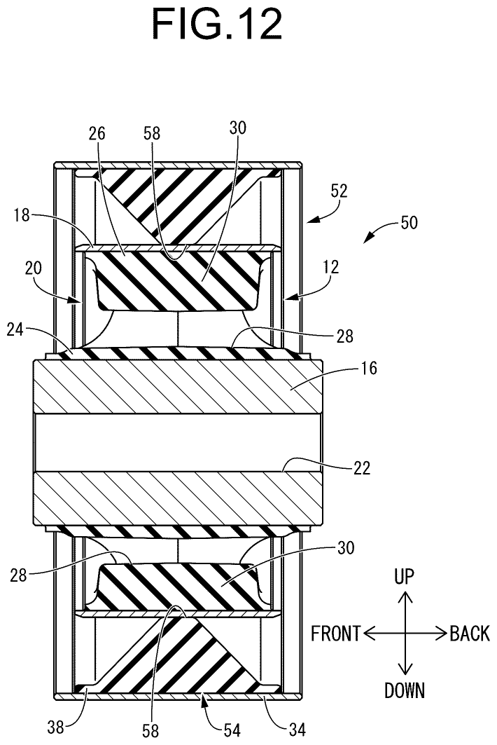

FIGS. 10 through 12 show a tubular vibration-damping device 50 for a motor mount as a second practical embodiment of the present disclosure. The tubular vibration-damping device 50 comprises the first molded article 12 and a second molded article 52. In the following description, explanation about the members and parts that are substantially the same as those of the first practical embodiment will be omitted by providing them with the same symbols in the figures.

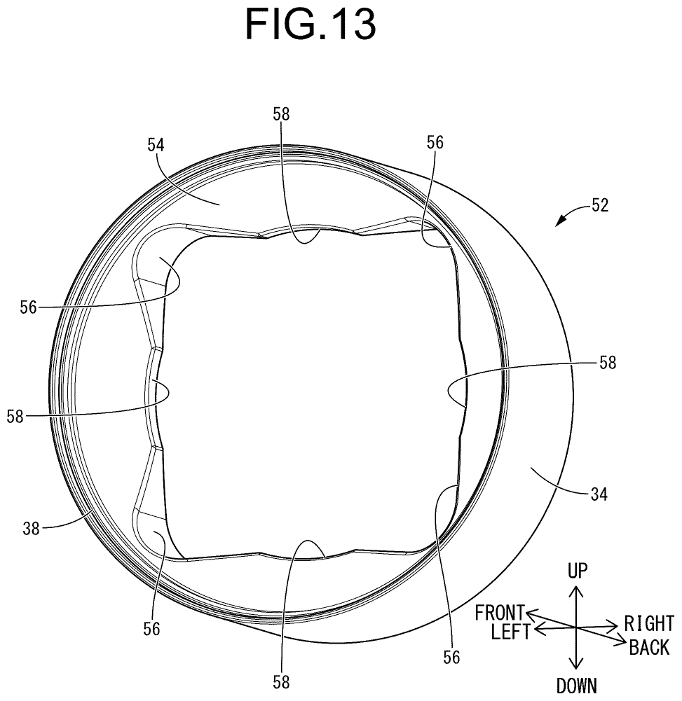

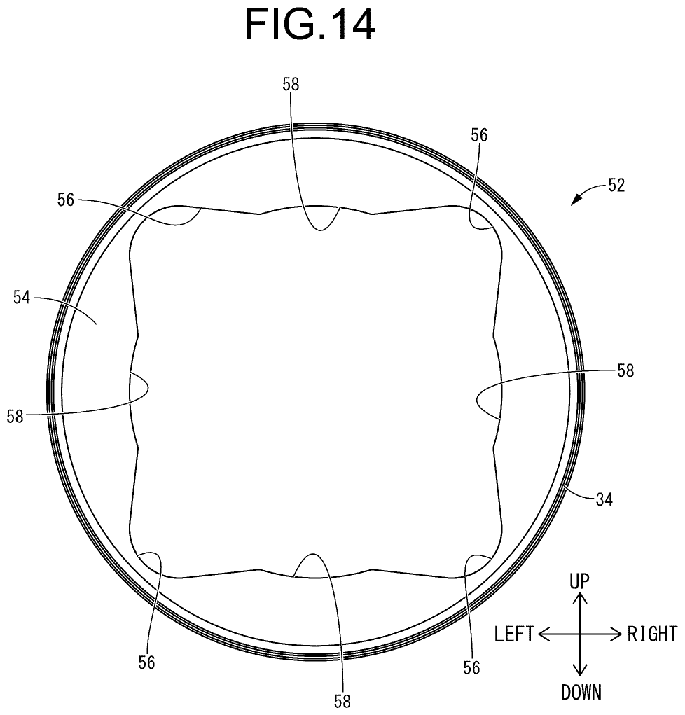

The second molded article 52 has a structure wherein an outer peripheral rubber elastic body 54 is bonded by vulcanization to the inner surface of the outer tube member 34, as shown in FIGS. 13 and 14. The outer peripheral rubber elastic body 54 is provided with bored recesses 56 as spring reducing parts. The bored recess 56 has a groove shape that extends with an almost constant cross section in the axial direction, opening to the inner surface of the outer peripheral rubber elastic body 54, and being formed through the outer peripheral rubber elastic body 54 in the axial direction so as to open to both axial sides of the outer peripheral rubber elastic body 54. The bored recess 56 has a groove cross sectional shape that expands in the circumferential direction as it goes radially inward. It is desirable that the plurality of bored recesses 56 are provided at equal intervals in the circumferential direction, and in this practical embodiment, four of them are provided at equal intervals in the circumferential direction.

The four bored recesses 56, 56, 56, 56 are spaced apart from each other in the circumferential direction, and a mating surface 58, which curves in the circumferential direction, is provided between the bored recesses 56, 56 adjacent in the circumferential direction. In this practical embodiment, four mating surfaces 58, 58, 58, 58 are provided, and those mating surfaces 58 are arcuate curved surfaces that constitute a cylindrical surface corresponding to the outer peripheral surface of the intermediate sleeve 18. The outer peripheral rubber elastic body 54 has a smaller projecting height dimension in the radial direction at the formation portion of the bored recess 56, and a larger projecting height dimension in the radial direction at the formation portion of the mating surface 58, located out of the bored recess 56 in the circumferential direction. In short, the outer peripheral rubber elastic body 54 of this practical embodiment is continuous over the entire circumference, and the projecting height dimension in the radial direction varies in the circumferential direction by the formation of the bored recesses 56. As can be seen also from FIG. 12, the axial length dimension of the radially inner end of the outer peripheral rubber elastic body 54 (the mating surface 58) should be within 30 to 70% of the projecting height dimension of the outer peripheral rubber elastic body 54 from the outer tube member 34, and more suitably within 40 to 60%.

As shown in FIGS. 10 to 12, the first molded article 12 is inserted and disposed radially inside the second molded article 52. The inner surface of the outer peripheral rubber elastic body 54 of the second molded article 52 is elastically pressed against the outer peripheral surface of the intermediate sleeve 18 of the first molded article 12, so that the intermediate sleeve 18 is elastically supported by the outer peripheral rubber elastic body 54. In this practical embodiment, the outer peripheral rubber elastic body 54 touches the outer peripheral surface of the intermediate sleeve 18 at the mating surface 58 and is separated from the intermediate sleeve 18 at the portion where the bored recess 56 is formed. Therefore, even when the outer peripheral rubber elastic body 54 is compressed in the radial direction by the assembly of the first molded article 12 and the second molded article 52, the bored recess 56 remains open without being completely collapsed.

With the tubular vibration-damping device 50 structured according to this practical embodiment, the outer peripheral rubber elastic body 54 is provided with the bored recesses 56. This lowers the spring of the outer peripheral rubber elastic body 54 in the radial direction when supporting the intermediate sleeve 18, compared to the outer peripheral rubber elastic body 36 of the first practical embodiment, which is uniformly shaped in cross section and continuous over the entire circumference. Therefore, the resonance frequency of the sub-vibration system constituted by the intermediate sleeve 18, the inner rubber elastic body 20 and the outer peripheral rubber elastic body 54 can be set still lower, and the vibration insulating action owing to the sub-vibration system can be effectively obtained over a still wider frequency range.

By the width in circumferential direction, the depth in radial direction, the shape in axial view, and the number of formation of the bored recesses 56, it is possible to easily tune the spring characteristics of the outer peripheral rubber elastic body 54 with a large degree of freedom, so as to achieve a higher degree of required vibration-damping performance.

The spring reducing part is not limited to the groove-shaped, bored recess 56 provided through the outer peripheral rubber elastic body in the axial direction shown in this practical embodiment. For example, in an outer peripheral rubber elastic body whose maximum projecting height in the radial direction is approximately constant over the entire circumference, it is possible to constitute the spring reducing part by a thin-walled portion with a small axial dimension partially provided in the circumferential direction. In addition, by two-color molding process of the outer peripheral rubber elastic body using a rubber material with a low spring constant partially in the circumferential direction, the portion formed by the rubber material with the low spring can be used as the spring reducing part.

Although the practical embodiments of this disclosure have been described in detail, the present disclosure is not limited by that specific description. For example, the bored hole 28 is not necessary for the inner rubber elastic body 20, and the inner rubber elastic body 20 may have a ring shape continuous around the entire circumference. When the inner rubber elastic body 20 is provided with the bored holes 28, the number of the bored holes 28 is not limited to four. Alternatively, three bored holes 28, 28, 28 may be formed in the inner rubber elastic body 20 and the inner rubber elastic body 20 may have a structure with three rubber legs 32, 32, 32.

Although it is desirable for the outer peripheral rubber elastic body 36 to be continuous over the entire circumference as shown in the aforesaid practical embodiment from the viewpoint of ease of manufacture, etc., the outer peripheral rubber elastic body 36 may be partially provided at multiple locations that are mutually separated in the circumferential direction, alternatively. In this case, the divided portions of the outer peripheral rubber elastic body in the circumferential direction constitute the spring reducing part. Besides, the outer peripheral rubber elastic body 36 is not necessarily limited to a tapered cross sectional shape whose axial dimension decreases as it goes radially inward.

In the stand-alone state of the second molded article 14, the inner diameter dimension of the outer peripheral rubber clastic body 36 may be larger than the outer diameter dimension of the intermediate sleeve 18. In this case, for example, the reduction in diameter of the outer tube member 34 causes the mating surface 40 of the outer peripheral rubber elastic body 36 to be pressed against the outer peripheral surface of the intermediate sleeve 18.

What is claimed is:

1. A tubular vibration-damping device for a motor mount comprising:
a first molded article including:
an inner shaft member;
an intermediate sleeve receiving the inner shaft member being inserted therein; and
an inner rubber elastic body connecting the inner shaft member and the intermediate sleeve elastically in a radial direction; and
a second molded article including:
an outer tube member; and
an outer peripheral rubber elastic body being bonded to an inner surface of the outer tube member, wherein
the intermediate sleeve of the first molded article is fitted radially into the outer peripheral rubber elastic body of the second molded article so as to combine the first molded article and the second molded article in a non-adhesive manner.

2. The tubular vibration-damping device for the motor mount according to claim 1, wherein the outer peripheral rubber elastic body has a tapered cross sectional shape whose axial length dimension gets smaller as it goes radially inward.

3. The tubular vibration-damping device for the motor mount according to claim 2, wherein an axial length dimension of a radially inner end of the outer peripheral rubber elastic body is within 30 to 200% of a projecting height dimension of the outer peripheral rubber elastic body to a radially inner side from the outer tube member.

4. The tubular vibration-damping device for the motor mount according to claim 1, wherein the outer peripheral rubber elastic body has an annular shape continuous over an entire circumference.

5. The tubular vibration-damping device for the motor mount according to claim 1, wherein the outer peripheral rubber elastic body has a spring reducing part reducing a spring in the radial direction provided partially in a circumferential direction.

6. The tubular vibration-damping device for the motor mount according to claim 1, wherein the inner rubber elastic body has a plurality of bored holes penetrating it in an axial direction.
